(19) United States
(12) Patent Application Publication
(10) Pub. No.: US 2020/0115048 A1
(43) Pub. Date: Apr. 16, 2020

(54) COMPLEX SYSTEM AND PROGRAM

(71) Applicant: TOYOTA JIDOSHA KABUSHIKI KAISHA, Toyota-shi (JP)

(72) Inventors: Tae SUGIMURA, Miyoshi-shi (JP); Hirotaka KARUBE, Toyota-shi (JP); Kazuki MATSUMOTO, Ohgaki-shi (JP); Makoto MORI, Nagakute-shi (JP); Jun KONDO, Nissin-shi (JP)

(73) Assignee: TOYOTA JIDOSHA KABUSHIKI KAISHA, Toyota-shi (JP)

(21) Appl. No.: 16/577,529

(22) Filed: Sep. 20, 2019

(30) Foreign Application Priority Data
Oct. 12, 2018 (JP) 2018-193764

(51) Int. Cl. B64C 39/02; G08G 5/02; G08G 1/00; G05D 1/00

(52) U.S. Cl. CPC B64C 39/024; G05D 1/0027; G08G 1/205; G08G 5/02

(57) ABSTRACT

A complex system includes an unmanned flying object, a vehicle in which the unmanned flying object is mountable and including a power supply device, a travel controller configured to transmit a travel instruction signal including a command to travel in a state where the unmanned flying object is mounted in the vehicle to the vehicle when flying of the unmanned flying object is disabled and traveling of the vehicle is enabled, and a flying controller configured to transmit a flying instruction signal including a command to fly away from the vehicle to the unmanned flying object when flying of the unmanned flying object is enabled and traveling of the vehicle is disabled. The vehicle travels in a state where the unmanned flying object is mounted in the vehicle based on the travel instruction signal, and the unmanned flying object flies away from the vehicle based on the flying instruction signal.

### INCORPORATION BY REFERENCE

The disclosure of Japanese Patent Application No. 2018-193764 filed on Oct. 12, 2018 including the specification, drawings and abstract is incorporated herein by reference in its entirety.

### BACKGROUND

### 1. Technical Field

The present disclosure relates to a complex system and a program.

### 2. Description of Related Art

In recent years, a vehicle or an unmanned flying object (a so-called drone or the like) has been used in the fields including rescue activities at the time of a disaster, research of a natural environment, and an entertainment element such as race competition (see, for example, Japanese Unexamined Patent Application Publication Nos. 2018-124763 (JP 2018-124763 A) and 2017-218142 (JP 2017-218142 A)).

### SUMMARY

However, rescue activities using vehicles or unmanned flying objects may be difficult according to external conditions such as a type of disaster (earthquake, tsunami, typhoon, storm, tornado, fire, and the like), and activities over long time may be difficult according to a time in which an unmanned flying object can operate. It has been difficult to say that advantages of vehicles and drones have been sufficiently utilized so far.

Therefore, the present disclosure, in an aspect, has been made in view of such circumstances, and an object of the present disclosure is to provide a complex system capable of performing an activity with advantages of both a vehicle and an unmanned flying object regardless of external conditions or a power situation on the device side, and a program therefor.

A first aspect of the disclosure relates to a complex system. The complex system includes an unmanned flying object; a vehicle in which the unmanned flying object is mountable, the vehicle including a power supply device for performing charging for drive electric power of the unmanned flying object; a travel controller configured to transmit a travel instruction signal including a command to travel in a state in which the unmanned flying object is mounted in the vehicle to the vehicle when flying of the unmanned flying object is disabled and traveling of the vehicle is enabled; and a flying controller configured to transmit a flying instruction signal including a command to fly away from the vehicle to the unmanned flying object when flying of the unmanned flying object is enabled and traveling of the vehicle is disabled, wherein the vehicle travels in a state in which the unmanned flying object is mounted in the vehicle based on the travel instruction signal; and the unmanned flying object flies away from the vehicle based on the flying instruction signal.

A second aspect of the disclosure relates to a program. The program causes an information processing device to execute a process of transmitting a travel instruction signal including a command to travel in a state in which an unmanned flying object is mounted in a vehicle to the vehicle when flying of the unmanned flying object is disabled and traveling of the vehicle is enabled, and transmitting a flying instruction signal including a command to fly away from the vehicle to the unmanned flying object when flying of the unmanned flying object is enabled and traveling of the vehicle is disabled, wherein the vehicle travels in a state in which the unmanned flying object is mounted in the vehicle based on the travel instruction signal, and the unmanned flying object flies away from the vehicle based on the flying instruction signal.

According to a technology of the present disclosure, since the complex system including the unmanned flying object and the vehicle is constructed and the unmanned flying object is charged with drive electric power from the power supply device included in the vehicle, the vehicle functions as a base station of the unmanned flying object. Further, when the unmanned flying object cannot fly and the vehicle can travel, the flying instruction signal is transmitted to the vehicle and the vehicle travels in a state in which the unmanned flying object is mounted in the vehicle, such that the unmanned flying object that cannot travel can be transported together with the vehicle. Further, when the unmanned flying object can fly and the vehicle cannot travel, the flying instruction signal is transmitted to the unmanned flying object and the unmanned flying object flies away from the vehicle that cannot travel, such that the unmanned flying object can move alone. As described above, by switching between movements of the unmanned flying object and the vehicle according to external conditions, for example, it becomes easy to reliably reach a rescue destination at the time of a disaster. Accordingly, it is possible to perform an activity with advantages of both of the vehicle and the unmanned flying object regardless of the external conditions or a power situation on the device side.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram illustrating a schematic configuration of a complex system 1 according to an embodiment;

FIG. 2 is a diagram illustrating an example of a hardware configuration of an information processing device 200 and a master device 300 according to the embodiment;

FIG. 3 is a perspective view illustrating a schematic configuration of an inverted moving object 100A (a small vehicle 100A) as an example of a small vehicle 100 according to the embodiment;

FIG. 4 is a block diagram illustrating a schematic system configuration of the inverted moving object 100A according to the embodiment;

FIG. 5 is a schematic diagram illustrating a schematic configuration of a personal moving object 100B (a small vehicle 100B) as an example of the small vehicle 100 according to the embodiment;

FIG. 6 is a block diagram illustrating a schematic system configuration of the personal moving object 100B according to the embodiment;

FIG. 7 is a block diagram illustrating a schematic system configuration of an unmanned flying object 500 according to the embodiment;

FIG. 8 is a diagram illustrating an entire schematic configuration of an example of a complex system according to an embodiment of the present disclosure;

FIG. 9A is a conceptual diagram illustrating an application scene of an example of the complex system according to the embodiment; and

FIG. 9B is a conceptual diagram illustrating the application scene of an example of the complex system according to the embodiment.

### DETAILED DESCRIPTION OF EMBODIMENTS

Hereinafter, an embodiment of the present disclosure will be described in detail with reference to the drawings. Further, the same elements are denoted by the same reference numerals and repeated description will be omitted. The embodiment to be described below is an example, and various modifications can be made without departing from the spirit of the disclosure. Further, the drawings include schematic or conceptual ones, and do not necessarily match actual dimensions, ratios, or the like, and dimensions or ratios of the same or similar elements may differ from one drawing to another drawing.

In the embodiment, a complex system including an unmanned flying object and a vehicle is constructed, and the unmanned flying object is charged with drive power from a power supply device included in the vehicle, such that the vehicle functions as a base station (an electric power station) of the unmanned flying object. Further, when the unmanned flying object cannot fly and the small vehicle can travel, the flying instruction signal is transmitted to the vehicle and the vehicle travels in a state in which the unmanned flying object is mounted in the vehicle, such that the unmanned flying object that cannot travel can be transported together with the vehicle. Further, when the unmanned flying object can fly and the vehicle cannot travel, the flying instruction signal is transmitted to the unmanned flying object and the unmanned flying object flies away from the vehicle that cannot travel, such that the unmanned flying object moves alone. As described above, by switching between movements of the unmanned flying object and the vehicle according to external conditions, for example, it becomes easy to reliably reach a rescue destination at the time of a disaster.

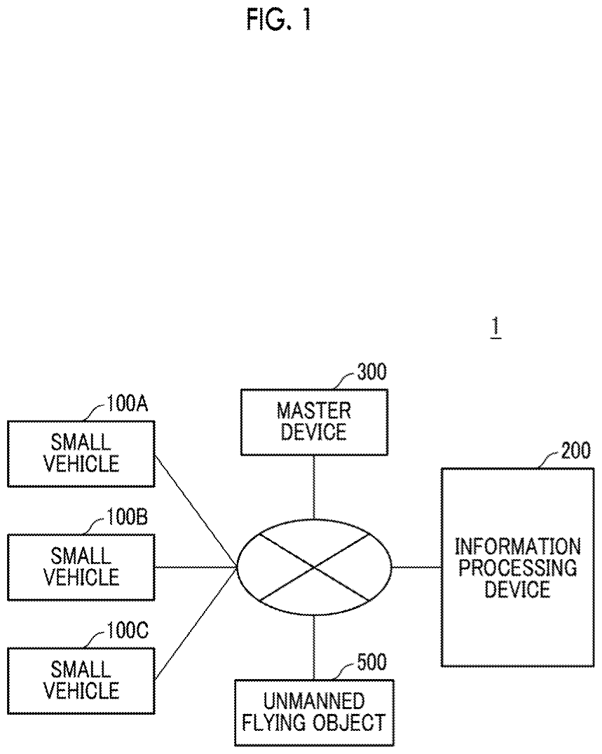

FIG. 1 is a diagram illustrating a schematic configuration of a complex system 1 according to the embodiment. As illustrated in FIG. 1, the complex system 1 includes a small vehicle 100A, a small vehicle 100B, a small vehicle 100C, an information processing device 200, a master device 300, and an unmanned flying object 500 that can be remotely manipulated for driving. All or some of these vehicles or devices are mutually communicatively connected via a communication network. The communication network may be, for example, any one of the Internet, a LAN, a mobile communication network, Bluetooth (registered trademark), WiFi (Wireless Fidelity), other communication lines, a combination thereof, and the like. The number of the small vehicles 100A to 100C (for example, personal mobility), the information processing device 200 (for example, a server), the master device 300, and the unmanned flying object 500 is not limited to the illustrated example. Therefore, an appropriately needed number of small vehicles 100A to 100C, information processing device 200, master device 300, and unmanned flying object 500 may be provided. Hereinafter, the small vehicles 100A to 100C are simply referred to as a “small vehicle 100” when the small vehicles 100A to 100C are collectively expressed without being separately distinguished. As described above, the small vehicle 100 (the small vehicles 100A to 100C) corresponds to an example of a “vehicle” in the present disclosure.

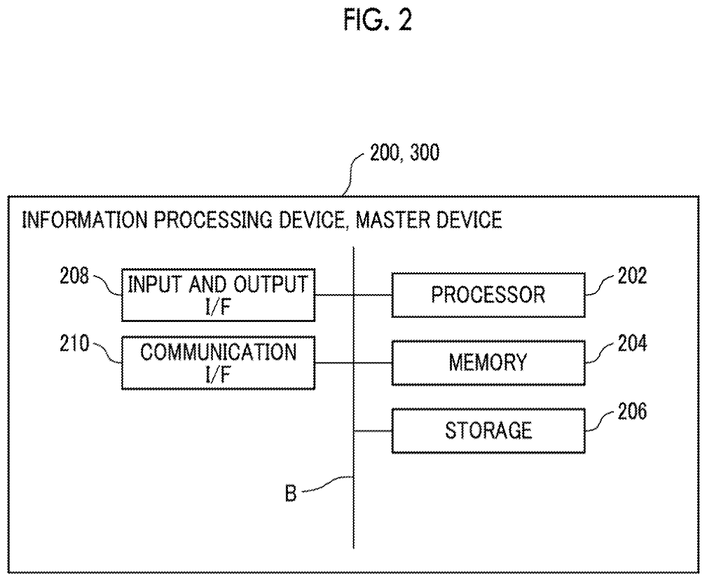

FIG. 2 is a diagram illustrating an example of a hardware configuration of the information processing device 200 and the master device 300 according to the embodiment. As illustrated in FIG. 2, each of the information processing device 200 and the master device 300 includes a processor 202, a memory 204, a storage 206, an input and output interface (input and output I/F) 208, and a communication interface (a communication I/F) 210. Respective components of the hardware (HW) of the information processing device 200 are mutually connected via, for example, a bus B. The information processing device 200 realizes at least functions or methods described in the embodiment through cooperation of the processor 202, the memory 204, the storage 206, the input and output I/F 208, and the communication I/F 210.

The processor 202 executes at least functions or methods that are realized by code or instructions included in a program stored in the storage 206. Examples of the processor 202 include a central processing unit (CPU), a micro processing unit (MPU), a GPU, a microprocessor, a processor core, a multiprocessor, an application-specific integrated circuit (ASIC), and a field programmable gate array (FPGA).

The memory 204 temporarily stores the program loaded from the storage 206 and provides a work area to the processor 202. Various pieces of data generated while the processor 202 is executing the program are also temporarily stored in the memory 204. The memory 204 includes, for example, a random access memory (RAM) and a read only memory (ROM).

The storage 206 stores, for example, the program that is executed by the processor 202. The storage 206 includes, for example, a hard disk drive (HDD), a solid state drive (SSD), and a flash memory.

The input and output I/F 208 includes an input device that inputs various manipulations to each of the information processing device 200 and the master device 300, and an output device that outputs a processing result of the information processing device 200.

The communication I/F 210 performs transmission and reception of various pieces of data via the network. The communication may be executed by a cable or wirelessly, and any communication protocol may be used as long as communication with each other is possible. The communication I/F 210 has a function of executing communication between the small vehicle 100, the information processing device 200, the master device 300, and the unmanned flying object 500 via the network. Further, the communication I/F 210 transmits various pieces of data to the small vehicle 100, the information processing device 200, the master device 300, and the unmanned flying object 500 according to an instruction from the processor 202.

The program for operating the complex system 1 according to the embodiment may be provided in a state in which the program is stored in a computer-readable storage medium. The storage medium can store the program in a “non-transitory tangible medium”. Further, the program includes, for example, a software program or a computer program.

Furthermore, at least some of processes in the information processing device 200 and the master device 300 may be realized by cloud computing configured of one or more computers. In addition, at least some of processes in the information processing device 200 may be performed by the master device 300 or another information processing device 200. At least some of processes in the master device 300 may be performed by the information processing device 200 or another master device 300. In this case, at least some of processes of each functional unit realized by the processor 202 can be performed by an alternative device.

The master device 300 is a device for controlling and managing operations of the small vehicle 100 and the unmanned flying object 500 based on a command from information processing device 200. Further, the master device 300 may have, for example, a function of acquiring generated or notified emergency signals or various information signals (for example, a signal indicating a situation of earthquake, tsunami, landslide, typhoon, tornado, storm, fire, or the like, an occurrence prediction signal thereof, or traffic information) at the time of occurrence of a disaster, relaying the signals, and transmitting the signals to the small vehicle 100, the unmanned flying object 500, and the like. In this regard, the master device 300 functions as a hub device or a central device. Further, any one of the small vehicles 100 or any one of the information processing devices 200 may function as the master device 300. In this case, one of the small vehicles 100, one of the information processing devices 200, and the master device 300 correspond to an example of the “information processing device” in the present disclosure.

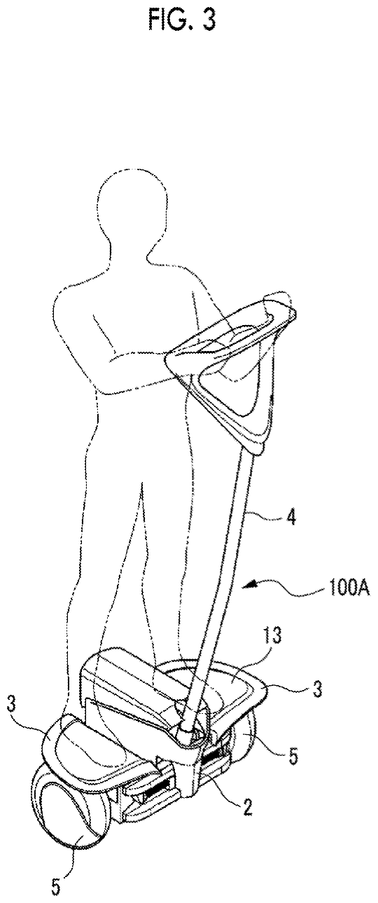

FIG. 3 is a perspective view illustrating a schematic configuration of the inverted moving object 100A (the small vehicle 100A) as an example of the small vehicle 100 according to the embodiment. The inverted moving object 100A according to the embodiment includes, for example, a vehicle body 2, a pair of right and left step portions 3 that are attached to the vehicle body 2 and on which an occupant appears, and a manipulation handle 4 that is tiltably attached to the vehicle body 2 and gripped by the occupant, a pair of right and left drive wheels 5 rotatably attached to the vehicle body 2, and a power supply device 13 described below.

The inverted moving object 100A according to the embodiment is configured, for example, as a coaxial two-wheeled vehicle in which the respective drive wheels 5 are coaxially disposed and travels while maintaining an inverted state. The inverted moving object 100A is configured to move forward and backward by a centroid of the occupant being moved forward and backward and each step portion 3 of the vehicle body 2 being tilted forward and backward, and to turn right and left by the centroid of the occupant being moved right and left and the step portion 3 of the vehicle body 2 being tilted right and left. Although the above-described coaxial two-wheeled vehicle is applied as the inverted moving object 100A, the present disclosure is not limited thereto, and can be applied to any moving object traveling while maintaining an inverted state.

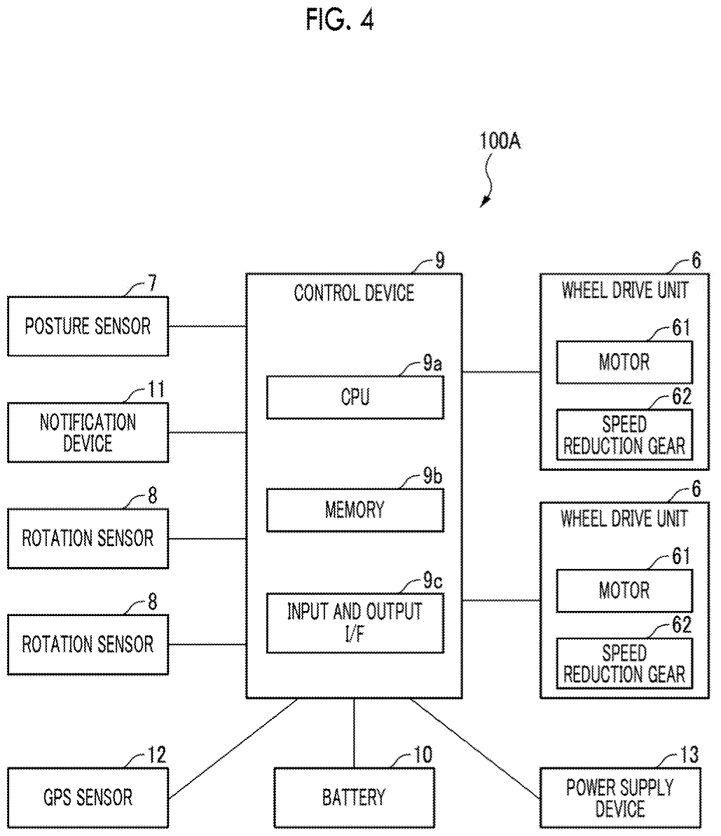

FIG. 4 is a block diagram illustrating a schematic system configuration of the inverted moving object 100A according to the embodiment. The inverted moving object 100A according to the embodiment includes a pair of wheel drive units 6 that drive the drive wheels 5, a posture sensor 7 that detects a posture of the vehicle body 2, a pair of rotation sensors 8 that detect rotation information of the respective drive wheels 5, a control device 9 that controls each wheel drive unit 6, a battery 10 that supplies power to the wheel drive unit 6 and the control device 9, a notification device 11 capable of outputting sound, a GPS sensor 12 that senses position information, and a power supply device 13 in which the unmanned flying object 500 is mounted (placed and fixed) and that performs power supply to the unmanned flying object 500.

The respective wheel drive units 6 are built in the vehicle body 2 and drive the pair of right and left drive wheels 5. The respective wheel drive units 6 can rotationally drive the pair of drive wheels 5 independently. Each wheel drive unit 6 can include, for example, a motor 61, and a speed reduction gear 62 connected to a rotation shaft of the motor 61 so that power can be transmitted to the rotation shaft of the motor 61.

The posture sensor 7 is provided in the vehicle body 2 and detects and outputs posture information of the vehicle body 2, the manipulation handle 4, or the like. The posture sensor 7 detects posture information when the inverted moving object 100A travels, and includes, for example, a gyro sensor or an acceleration sensor. When the occupant tilts the manipulation handle 4 forward or backward, each step portion 3 is tilted in the same direction, but the posture sensor 7 detects posture information corresponding to the tilting. The posture sensor 7 outputs the detected posture information to the control device 9.

Each rotation sensor 8 is provided on each of the drive wheels 5 or the like, and can detect rotation information such as a rotation angle, a rotation angular velocity, and a rotation angular acceleration of each drive wheel 5. Each rotation sensor 8 includes, for example, a rotation encoder, and a resolver. Each rotation sensor 8 outputs the detected rotation information to the control device 9.

The battery 10 is, for example, a power supply built in the vehicle body 2 and includes a lithium ion storage battery or the like. The battery 10 supplies power to, for example, each wheel drive unit 6, the control device 9, and other electronic devices.

The control device 9 generates and outputs a control signal for driving and controlling each wheel drive unit 6 based on detection values output from various sensors mounted in the inverted moving object 100A. The control device 9, for example, executes predetermined arithmetic processing based on the posture information output from the posture sensor 7, the rotation information of each drive wheel 5 output from each rotation sensor 8, and the like, and outputs a needed control signal to each wheel drive unit 6. The control device 9 controls each wheel drive units 6, for example, to execute inversion control to maintain the inverted state of the inverted moving object 100A.

The control device 9 includes a CPU 9a, a memory 9b, and an input and output I/F 9c in order to realize the above process. The CPU 9a executes at least functions or methods that are realized by code or instructions included in a program stored in the memory 9b.

The memory 9b stores the program and provides a work area to the CPU 9a. The memory 9b also temporarily stores various pieces of data that are generated while the CPU 9a is executing the program. The memory 9b includes, for example, a random access memory (RAM) and a read only memory (ROM).

The input and output I/F 9c includes an input device that inputs various manipulations to the control device 9, and an output device that outputs a processing result of the control device 9 and a processing result of the information processing device 200. In the input and output I/F 9c, an input device and an output device may be integrally provided or the input device and the output device may be provided separately, and the input device and the output device may be singular or plural. Further, the input and output I/F 9c may be provided integrally with the CPU 9a or the memory 9b, or may be provided separately from the CPU 9a or the memory 9b.

The input device is not particularly limited, and may be one of various devices capable of transferring input information related to an input manipulation from the occupant of the inverted moving object 100A or the like to the CPU 9a, may be any one type of device, or may be a combination of a plurality of types of devices. More specifically, examples of the input device may include a touch panel, a touch display, a keyboard, a pointing device such as a mouse, a camera (which may also be used as an imaging device; a manipulation input device based on an image), and a microphone (a manipulation input device based on voice).

The output device is not particularly limited, and may be any of various devices capable of outputting the processing result of the control device 9 and the information processing device 200, may be any one type of device, or may be a combination of a plurality of devices. More specifically, examples of the output device may include a touch panel, a touch display, a monitor (a liquid crystal display, an organic EL display, a head mounted display, a hologram, projection mapping, a speaker (an output device based on sound), a 2D printer (an output device based on text), and a 3D printer (an output device based on molding).

The notification device 11 is one specific example of notification means. The notification device 11 sends a notification to an occupant or a person outside the vehicle according to a notification signal from the control device 9. The notification device 11 includes, for example, a speaker that outputs a sound, and the input and output I/F 9c may function as a notification device 160.

The GPS sensor 12 acquires current position information of the inverted moving object 100A. The GPS sensor 12 is, for example, a part of a position information measurement system using an artificial satellite, and receives radio waves from a large number of GPS satellites to measure position (longitude, latitude, and altitude) with high precision at any point on the earth. The inverted moving object 100A may include an imaging device and a communication device.

The power supply device 13 is, for example, a device for performing charging for drive electric power of the unmanned flying object 500 using the battery 10 through wireless power transmission. A scheme for the wireless power transmission is not particularly limited, and a specific example of the scheme may a non-radiation scheme such as a magnetic field coupling scheme (an electromagnetic induction scheme, a magnetic resonance scheme, or an annular solenoid scheme), an electric field coupling scheme, and an evanescent wave scheme, or a radiation scheme such as a laser scheme, a microwave scheme (a high power type or a weak electromagnetic wave type), and an ultrasonic scheme.

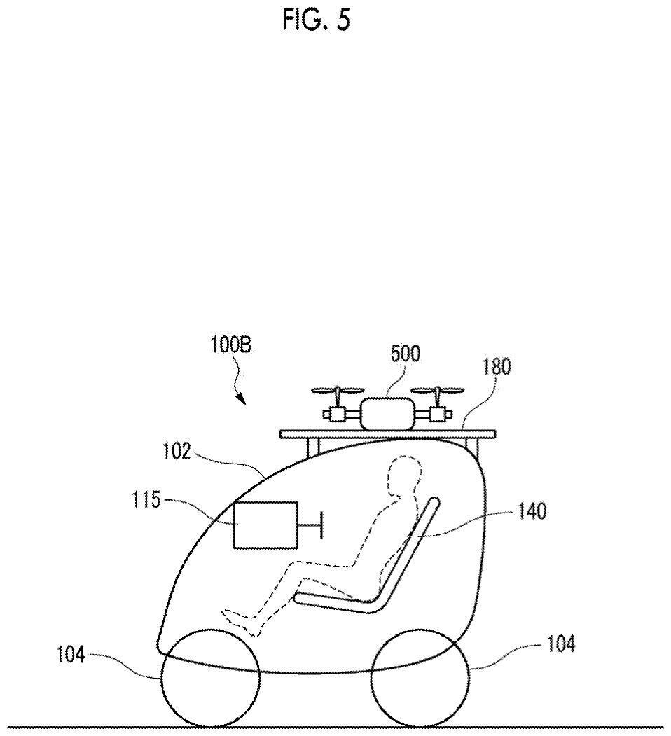

FIG. 5 is a schematic diagram illustrating a schematic configuration of the personal moving object 100B (the small vehicle 100B) as an example of the small vehicle 100 according to the embodiment. The personal moving object 100B according to the embodiment includes, for example, a vehicle body 102, a seat unit 140 that is attached to the vehicle body 102 and seated by an occupant (a driver), a manipulation unit 115 that is gripped by the occupant and enables driving of the personal moving object 100B, a pair of right and left drive wheels 104 that are rotatably mounted in the vehicle body 2, and a power supply device 180 to be described below.

The personal moving object 100B according to the embodiment is, for example, a small vehicle for one or two persons, and the drive wheels 104 may include two front drive wheels and one rear drive wheel. The movement of the personal moving object 100B may be controlled by being manipulated by the occupant, but the personal moving object 100B is controlled to autonomously travel based on the image captured by the imaging device 170 by being switched to an autonomous traveling mode.

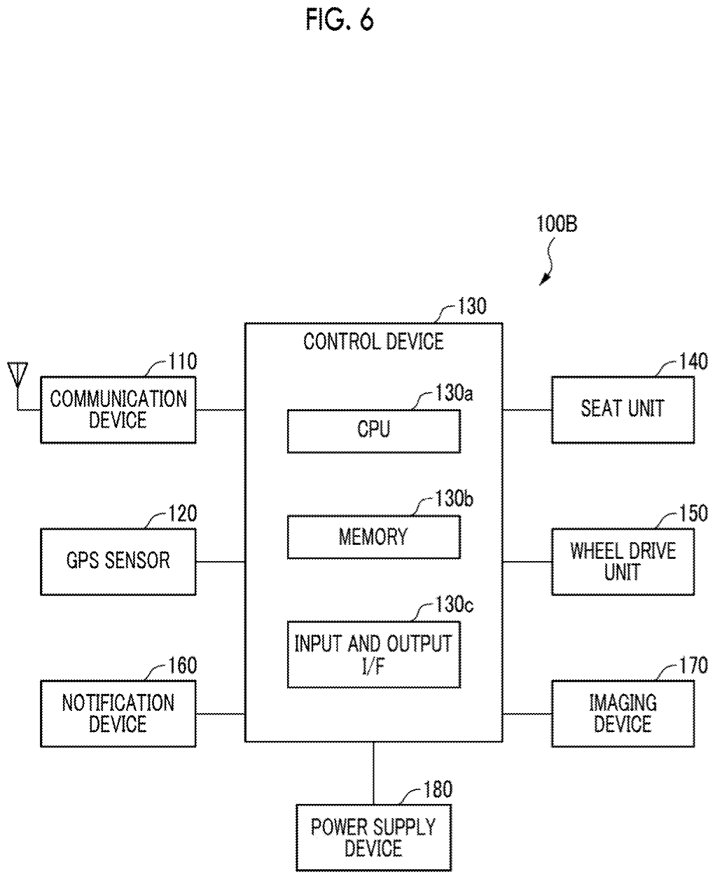

FIG. 6 is a block diagram illustrating a schematic system configuration of a personal moving object 100B according to the embodiment. The personal moving object 100B according to the embodiment includes a pair of wheel drive units 150 that drive the respective drive wheels 104, a seat unit 140 in which an occupant can seat, a communication device 110 that enables communication with an external device, an manipulation unit 115 that enables a driver to perform a driving manipulation, a GPS sensor 120 that acquires position information, a notification device 160 capable of outputting sound, an imaging device 170 that captures an image, and a power supply device 180 in which an unmanned flying object is mounted (placed and fixed) 500 and that supplies power to the unmanned flying object 500.

The GPS sensor 120 acquires current position information of the personal moving object 100B. The GPS sensor 120 is, for example, a part of a position information measurement system using an artificial satellite, and receives radio waves from a large number of GPS satellites to measure position (longitude, latitude, and altitude) with high precision at any point on the earth.

The control device 130 generates a control signal for driving and controlling each wheel drive unit 150 based on detection values of various sensors mounted in the personal moving object 100B or manipulation content of an occupant using the manipulation unit 115, and outputs the control signal.

The control device 130 includes a CPU 130a, a memory 130b, and an input and output I/F 130c in order to realize the above process. The CPU 130a executes at least functions or methods that are realized by code or instructions included in a program stored in the memory 130b.

The memory 130b stores the program and provides a work area to the CPU 130a. The memory 130b also temporarily stores various pieces of data that are generated while the CPU 130a is executing the program. The memory 130b includes, for example, a random access memory (RAM) and a read only memory (ROM).

The input and output I/F 130c includes an input device that inputs various manipulations to the control device 130, and an output device that outputs a processing result of the control device 130 and a processing result of the information processing device 200. In the input and output I/F 130c, an input device and an output device may be integrally provided or the input device and the output device may be provided separately, and the input device and the output device may be singular or plural. Further, the input and output I/F 130c may be provided integrally with the CPU 130a or the memory 130b, or may be provided separately from the CPU 130a or the memory 130b.

The input device is not particularly limited, and may be one of various devices capable of transferring input information related to an input manipulation from the occupant (a driver) of the personal moving object 100B or the like to the CPU 130a, may be any one type of device, or may be a combination of a plurality of types of devices. More specifically, examples of the input device may include a touch panel, a touch display, a keyboard, a pointing device such as a mouse, a camera (which may also be used as an imaging device; a manipulation input device based on an image), and a microphone (a manipulation input device based on voice).

The output device is not particularly limited, and may be any of various devices capable of outputting the processing result of the control device 130 and the information processing device 200, may be any one type of device, or may be a combination of a plurality of devices. More specifically, examples of the output device may include a touch panel, a touch display, a monitor (a liquid crystal display, an organic EL display, a head mounted display, a hologram, projection mapping, a speaker (an output device based on sound), a 2D printer (an output device based on text), and a 3D printer (an output device based on molding).

The seat unit 140 is a seat unit on which an occupant can seat, and may have a reclining structure.

Each wheel drive unit 150 is built in the vehicle body 102 and drives the pair of right and left drive wheels 104 or the one rear drive wheel 104.

The notification device 160 is one specific example of notification means. The notification device 160 sends a notification to an occupant or a person outside the vehicle according to a notification signal from the control device 130. The notification device 160 includes, for example, a speaker that outputs a sound, and the input and output I/F 130c may function as a notification device 160.

The imaging device 170 is provided, for example, at a position at which a thing in the front of the personal moving object 100B can be imaged. The imaging device 170 outputs, to the control device 130, a captured image obtained by imaging the thing in the front of the personal moving object 100B.

The power supply device 180 is, for example, a device for performing charging for drive electric power of the unmanned flying object 500 using a battery or a power supply of the personal moving object 100B through wireless power transmission. A scheme for the wireless power transmission is not particularly limited, and a specific example of the scheme may a non-radiation scheme such as a magnetic field coupling scheme (an electromagnetic induction scheme, a magnetic resonance scheme, or an annular solenoid scheme), an electric field coupling scheme, and an evanescent wave scheme, or a radiation scheme such as a laser scheme, a microwave scheme (a high power type or a weak electromagnetic wave type), and an ultrasonic scheme.

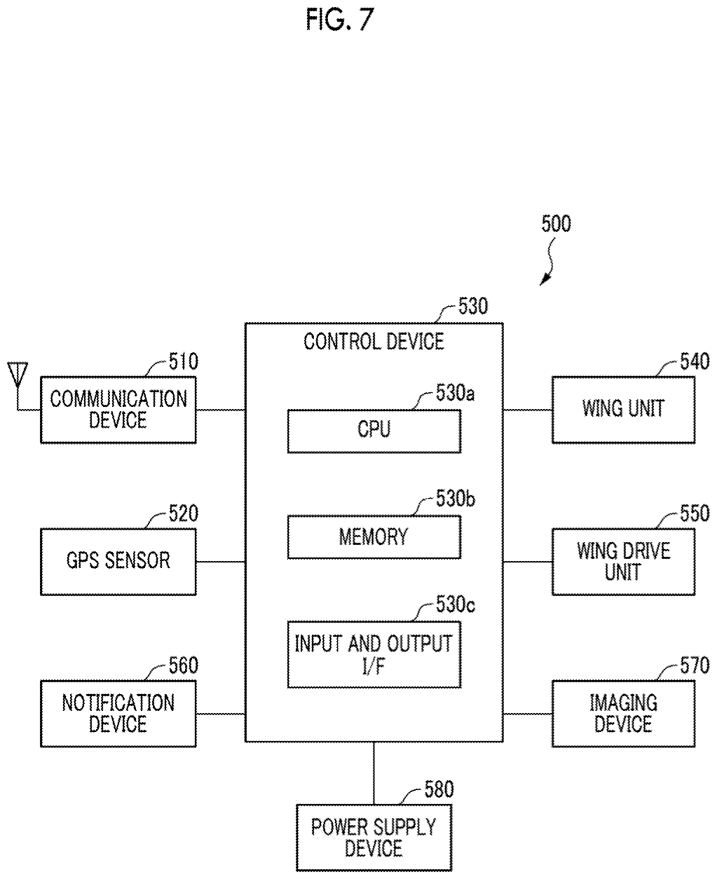

FIG. 7 is a block diagram illustrating a schematic system configuration of the unmanned flying object 500 according to the embodiment. The unmanned flying object 500 according to the embodiment includes a wing unit 540 including a wing mechanism such as a rotation wing, a wing drive unit 550 that drives the wing unit 540, a GPS sensor 520 that acquires position information, a notification device 560 capable of outputting sound, an imaging device 570 that captures an image, and a power reception device 580 that receives power to be supplied to the unmanned flying object 500.

The GPS sensor 520 acquires current position information of the unmanned flying object 500. The GPS sensor 520 is, for example, a part of a position information measurement system using an artificial satellite, and receives radio waves from a large number of GPS satellites to measure position (longitude, latitude, and altitude) with high precision at any point on the earth.

A control device 530 generates a control signal for driving and controlling the wing drive unit 550 based on detection values of various sensors mounted in the unmanned flying object 500 or remote manipulation content, and outputs the control signal.

The control device 530 includes a CPU 530a, a memory 530b, and an input and output I/F 530c in order to realize the above process. The CPU 530a executes at least functions or methods that are realized by code or instructions included in a program stored in the memory 530b.

The memory 530b stores the program and provides a work area to the CPU 530a. The memory 530b also temporarily stores various pieces of data that are generated while the CPU 530a is executing the program. The memory 530b includes, for example, a random access memory (RAM) and a read only memory (ROM).

The input and output I/F 530c includes an input device that inputs various manipulations to the control device 530, and an output device that outputs a processing result of the control device 530 and a processing result of the information processing device 200, as needed. In the input and output I/F 530c, an input device and an output device may be integrally provided or the input device and the output device may be provided separately, and the input device and the output device may be singular or plural. Further, the input and output I/F 530c may be provided integrally with the CPU 530a or the memory 530b, or may be provided separately from the CPU 530a or the memory 530b.

The input device is not particularly limited, and may be one of various devices capable of transferring input information related to an input manipulation from an operator or a processing result of the information processing device 200 or the like to the CPU 530a, may be any one type of device, or may be a combination of a plurality of types of devices.

The output device is not particularly limited, and may be any of various devices capable of outputting the processing result of the control device 530 and the information processing device 200, may be any one type of device, or may be a combination of a plurality of devices. More specifically, examples of the output device may include a touch panel, a touch display, a monitor (a liquid crystal display, an organic EL display, a head mounted display, a hologram, projection mapping, a speaker (an output device based on sound), a 2D printer (an output device based on text), and a 3D printer (an output device based on molding).

The notification device 560 is one specific example of notification means. The notification device 560 sends a notification to a person on the ground according to a notification signal from the control device 530. The notification device 560 includes, for example, a speaker that outputs a sound, and the input and output I/F 530c may function as a notification device 560.

The imaging device 570 is provided, for example, at a position at which, for example, all directions (any positions on front, rear, left, right, upper, and lower sides) of the unmanned flying object 500 are imaged. The imaging device 570 outputs a captured image obtained by imaging all the directions of the unmanned flying object 500 to the control device 530.

The power reception device 580 is, for example, a device for receiving the power transmitted through wireless power transmission from the battery or power supply of the personal moving object 100B via the power supply device 180. A scheme for the wireless power transmission is not particularly limited, and a specific example of the scheme may a non-radiation scheme such as a magnetic field coupling scheme (an electromagnetic induction scheme, a magnetic resonance scheme, or an annular solenoid scheme), an electric field coupling scheme, and an evanescent wave scheme, or a radiation scheme such as a laser scheme, a microwave scheme (a high power type or a weak electromagnetic wave type), and an ultrasonic scheme.

### First Embodiment

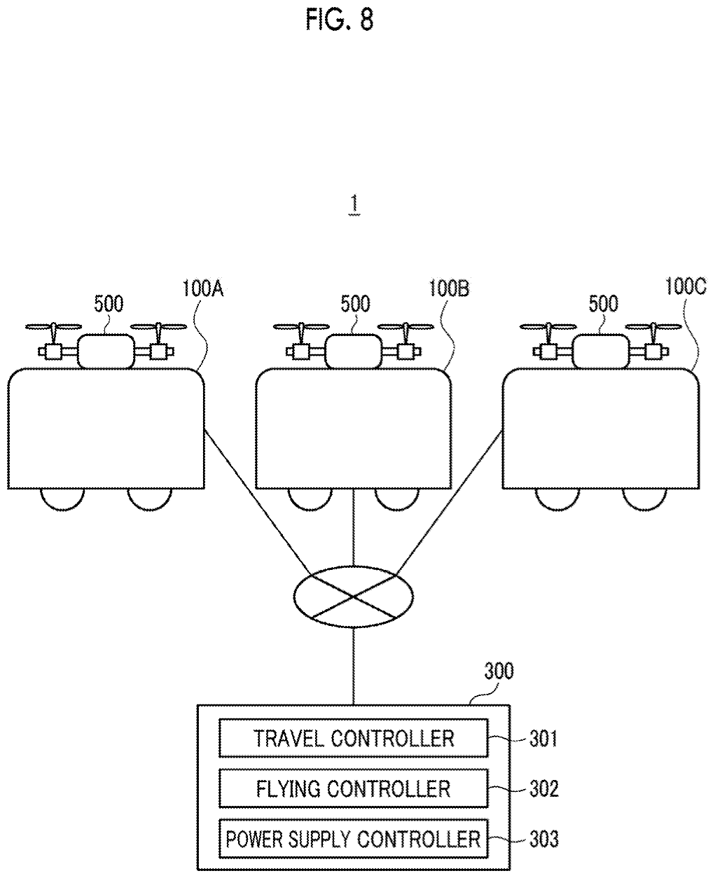

FIG. 8 is a diagram illustrating a general schematic configuration of an example of the complex system constructed by the plurality of personal moving objects 100 as examples of the small vehicles 100, the information processing device 200, the master device 300, and the unmanned flying object 500 in the embodiment. FIG. 8 partially includes a functional block diagram. The complex system 1 of the embodiment includes functional units including at least a plurality of personal moving objects 100 (100A, 100B, and 100C), an unmanned flying object 500 mounted in the power supply device 180 of each personal moving object 100, a travel controller 301, a flying controller 302, and a power supply controller 303. Accordingly, the complex system 1 is configured as a rescue system in which the vehicle and the unmanned flying object cooperate with each other, move to, for example, a disaster occurrence place or a surrounding area at the time of disaster and perform rescue activity, as needed.

Further, functional units such as the travel controller 301, the flying controller 302, and the power supply controller 303 are realized by cooperation with, for example, the processor 202, the memory 204, the storage 206, the input and output I/F 208, and the communication I/F 210 included in the master device 300. That is, the processor 202 of the master device 300 illustrated in FIG. 2 described above develops, in the memory 204 (for example, a RAM), various programs needed for construction and operation of the complex system 1 stored in the storage 206. The processor 202 interprets and executes the various programs developed in the memory 204 and controls each hardware component to realize each functional unit. Each function realized by the master device 300 may be realized by the processor 202 such as a general-purpose CPU, or some or all of the functions may be realized by one or more dedicated processors 202.

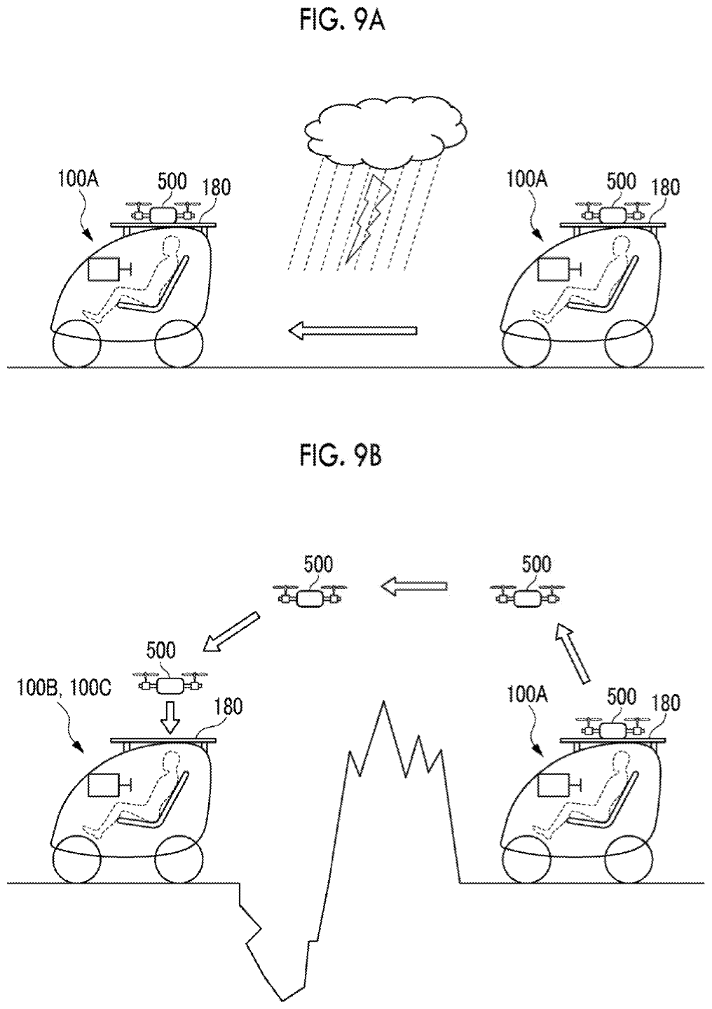

Here, FIGS. 9A and 9B are conceptual diagrams illustrating application scenes of the complex system 1 according to the embodiment, and also conceptual diagrams illustrating a state in which the complex system 1 is operating under different external conditions. Among these, FIG. 9A illustrates a case in which weather is worse (occurrence of typhoon, storm, or tornado) or a large fire occurs and the unmanned flying object 500 cannot fly when the complex system 1 of the embodiment moves toward a destination, for example, in order to perform a rescue activity at the time of a fire.

In this case, when traveling of the personal moving object 100A is possible, that is, passage of an air route cannot be secured but passage of a land route can be secured, the travel controller 301 generates a travel instruction signal including a command to travel toward a destination in a state in which unmanned flying object 500 is mounted with respect to the personal moving object 100A, and transmits the travel instruction signal to the personal moving object 100A. The personal moving object 100A that has received the travel instruction signal via control device 130 continues traveling on the land route toward the destination based on the instruction in a state in which the unmanned flying object 500 is mounted.

On the other hand, FIG. 9B illustrates a case in which the personal moving object 100A cannot travel according to generation of an obstacle or the like due to a disaster (earthquake, tsunami, landslide, fire, or the like) when the complex system 1 of the embodiment moves toward a destination, for example, in order to perform a rescue activity at the time of a disaster.

In this case, when flying of the unmanned flying object 500 is possible, that is, passage of the land route cannot be secured but passage of the air can be secured, the flying controller 302 generates a flying instruction signal including a command to fly toward the personal moving bodies 100B and 100C located away from (taken off) the personal moving object 100A and closer to the destination with respect to the unmanned flying object 500 mounted in the personal moving object 100A, and transmits the flying instruction signal to the unmanned flying object 500. The unmanned flying object 500 that has received the flying instruction signal via the control device 530 flies on the land route independently away from the personal moving object 100A based on the instruction. The unmanned flying object 500 approaching the personal moving objects 100B and 100C, for example, images the personal moving objects 100B and 100C using the imaging device 570, determines whether or not another unmanned flying object 500 is mounted based on an image processing result, and lands on the power supply device 180 of the personal moving object 100B and 100C when the other unmanned flying object 500 is not mounted.

When the unmanned flying object 500 lands on the power supply device 180, power supply to the unmanned flying object 500 may be started immediately after the landing or, of course, the power supply may be performed at an appropriate timing when the amount of charge is larger than a predetermined value and is sufficient. Further, an information signal as to whether or not another unmanned flying object 500 is mounted in the personal moving object 100B or 100C may be transmitted from the personal moving object 100B or 100C, the information processing device 200, or the master device 300 to the unmanned flying object 500.

According to the complex system 1 configured as described above, since the unmanned flying object 500 is charged with the drive electric power from the power supply device 180 included in the small vehicle 100 such as the personal moving object 100A to 100C, the small vehicle 100 can be caused to function as a relay base station of the unmanned flying object 500. Further, when the unmanned flying object 500 cannot fly and the small vehicle 100 can travel, the flying instruction signal is transmitted to the small vehicle 100 and the small vehicle 100 travels in a state in which the unmanned flying object 500 is mounted in the small vehicle 100, such that the unmanned flying object 500 that cannot travel can be transported together with the small vehicle 100. Further, when the unmanned flying object 500 can fly and the small vehicle 100 cannot travel, the flying instruction signal is transmitted to the unmanned flying object 500 and the unmanned flying object 500 flies away from the small vehicle 100 that cannot travel, such that the unmanned flying object 500 can move alone. As described above, by switching between movements of the unmanned flying object 500 and the small vehicle 100 according to external conditions, for example, it becomes easy to reliably reach the rescue destination at the time of a disaster. As a result, it is possible to realize a rescue activity with advantages of both of the small vehicle 100 and the unmanned flying object 500 regardless of the external conditions or a power situation on the device side.

### Second Embodiment

For example, in a case in which weather is good unlike the external conditions illustrated in FIGS. 9A and 9B, a case in which flying of the unmanned flying object 500 and traveling of the personal moving object 100A are also possible is assumed. In this case, when the travel controller 301 of the master device 300 transmits a travel instruction signal to the personal moving object 100A so that the unmanned flying object 500 is transported in a state in which the unmanned flying object 500 is mounted in the personal moving object 100A, this is desirable in that a battery of the unmanned flying object 500 can be saved. On the other hand, when the flying controller 302 of the master device 300 transmits a flying instruction signal to the unmanned flying object 500 so that the unmanned flying object 500 is moved toward a destination as far as possible sequentially via the personal moving objects 100A to 100C, this is desirable in that the unmanned flying object 500 can reach a rescue destination early at the time of emergency.

Although the above embodiment and each example have been described above in detail as examples of the disclosure, the present disclosure is limited to the above embodiment and the modification example described above as described above and various modifications can be made without departing from the spirit of the disclosure. Further, the above embodiment and each example may be partially replaced or may be configured in combination appropriately. Further, for example, such changes can be made appropriately in each embodiment and each example. That is, for example, the travel controller 301, the flying controller 302, and the power supply controller 303 realized by the master device 300 in the complex system 1 illustrated in FIG. 8 may be realized by the information processing device 200 or the personal moving object 100A to 100C.

The complex system and the program of the present disclosure can be used widely and effectively for rescue activities at the time of a disaster, research of a natural environment, and activities in the fields in which vehicles or unmanned flying objects (so-called drones, or the like) including an entertainment element such as race competition are utilized.

What is claimed is:

1. A complex system comprising:
an unmanned flying object;
a vehicle in which the unmanned flying object is mountable, the vehicle including a power supply device for performing charging for drive electric power of the unmanned flying object;
a travel controller configured to transmit a travel instruction signal including a command to travel in a state in which the unmanned flying object is mounted in the vehicle to the vehicle when flying of the unmanned flying object is disabled and traveling of the vehicle is enabled; and
a flying controller configured to transmit a flying instruction signal including a command to fly away from the vehicle to the unmanned flying object when flying of the unmanned flying object is enabled and traveling of the vehicle is disabled, wherein:
the vehicle travels in a state in which the unmanned flying object is mounted in the vehicle based on the travel instruction signal; and
the unmanned flying object flies away from the vehicle based on the flying instruction signal.

2. The complex system according to claim 1, wherein the travel controller and the flying controller acquire external information, and determine whether or not flying of the unmanned flying object is enabled and whether or not traveling of the vehicle is enabled based on the external information.

3. The complex system according to claim 1, wherein the external information is at least one of disaster information or weather information.

4. The complex system according to claim 1, wherein:
the flying controller transmits, to the unmanned flying object, the flying instruction signal including a command to land on a vehicle different from the vehicle; and
the unmanned flying object lands on the different vehicle based on the flying instruction signal.

5. The complex system according to claim 1, wherein the power supply device performs charging for drive electric power of the unmanned flying object through wireless power transmission.

6. The complex system according to claim 1, wherein when flying of the unmanned flying object is enabled and traveling of the vehicle is enabled, the travel controller transmits the travel instruction signal to the vehicle, or the flying controller transmits the flying instruction signal to the unmanned flying object.

7. A program causing an information processing device to execute a process of
transmitting a travel instruction signal including a command to travel in a state in which an unmanned flying object is mounted in a vehicle to the vehicle when flying of the unmanned flying object is disabled and traveling of the vehicle is enabled, and
transmitting a flying instruction signal including a command to fly away from the vehicle to the unmanned flying object when flying of the unmanned flying object is enabled and traveling of the vehicle is disabled, wherein:
the vehicle travels in a state in which the unmanned flying object is mounted in the vehicle based on the travel instruction signal; and
the unmanned flying object flies away from the vehicle based on the flying instruction signal.
